(19) United States
(12) Patent Application Publication
(10) Pub. No.: US 2017/0158390 A1
(43) Pub. Date: Jun. 8, 2017

(54) POWDER DOSING CLOSURE

(71) Applicant: Mead Johnson Nutrition Company, Glenview, IL (US)

(72) Inventor: Margo E. Love, Evansville, IN (US)

(21) Appl. No.: 14/959,394

(22) Filed: Dec. 4, 2015

(51) Int. Cl. B65D 51/28; B65D 51/18; B65D 47/24; A61J 9/00

(52) U.S. Cl. CPC B65D 51/2828; A61J 9/00; B65D 51/18; B65D 47/247; B65D 2251/0018; B65D 2251/0078

(57) ABSTRACT

A method and apparatus for powder dosing a nutritional composition may include a container body and a closure removably coupled to the container body. A nutritive substance may be retained between an upper portion of the container body and the closure. The nutritive substance may be released and mixed with the contents of the container body prior to consumption. The nutritive substance may be sealed prior to use in order to prevent contamination of the nutritive substance.

### TECHNICAL FIELD

The present disclosure relates to apparatuses and methods for adding heat-sensitive nutrients to already sterilized infant formulas. Particularly, the disclosure relates to the use of definitive dosing to incorporate a powdered or liquid nutritive substance into the closure of a bottle containing infant formula.

### BACKGROUND ART

Many nutritive substances which would be beneficial if included in food or drink products are sensitive to heat, light, oxygen, and/or moisture. For example, a nutritive substance which is sensitive to heat cannot be added to a food or drink product that requires heat sterilization because the high sterilization temperatures may damage or destroy the nutritive substance. As a result of these limitations, containers have been developed that can separate the nutritive substance from the food or drink product prior to consumption. The user can then dispense the nutritive substances into the food or drink product just before consumption. The present disclosure, therefore, relates to a container which can separately contain a nutritive substance and a food or drink product and deliver the nutritive substance to the food or drink product just before consumption.

### SUMMARY

In an embodiment, the present disclosure provides an apparatus for powder dosing a nutritional composition comprising a container body having an upper portion adapted for removable receipt of a closure, the upper portion defining an opening therein, and a cavity defined by the container body, the cavity being in fluid communication with the upper portion opening. The container additionally comprises a closure removably coupled to the upper portion. The closure comprises an annular end wall, a plunger member molded in the annular end wall, a powder chamber formed inside of the closure and loaded with a nutritive substance, and a laminate seal. The laminate seal is bonded across the powder chamber and is adapted to peel when the plunger is depressed.

In another embodiment, the seal prevents contact between the nutritive substance and contents of the container body until the seal is peeled.

In yet another embodiment, the plunger comprises a first resin.

In still another embodiment, the plunger comprises a first resin and the annular end wall comprises a second resin.

In another embodiment, the powder chamber is spray-coated.

In one embodiment, the nutritive substance comprises a probiotic.

One embodiment includes a protective cover removably adhered to an outer surface of the closure and covering the plunger.

In a further embodiment, the protective cover also comprises a gripping tab to allow easy removal of the protective cover.

In another embodiment, the disclosure is directed to an apparatus for powder dosing a nutritional composition comprising a container body having an upper portion adapted for removable receipt of a closure, the upper portion defining an opening therein, and a cavity defined by the container body, the cavity being in fluid communication with the upper portion opening. Additionally, the embodiment comprises a closure removably coupled to the upper portion, the closure comprising a disk formed with an open lattice center and disposed between the container body and the closure, and a heat-sensitive ingredient deposited on the underside of the disk.

The apparatus may also include, in another embodiment, the disk including a disk ring along a circumference of the disk and sealingly positioned between the closure and the upper portion when the closure is coupled to the upper portion

One embodiment includes the closure being formed with a nipple.

A further embodiment includes the disk being permeable.

In another embodiment, the apparatus is inverted to expose the heat-sensitive ingredient to contents of the container body.

In a further embodiment, the heat-sensitive ingredient comprises a probiotic.

The disclosure is also directed, in an embodiment, to a method of manufacturing an apparatus for powder dosing a nutritional composition. The method includes providing a container body; providing a closure including an annular end wall and a hood wall; inserting a plunger in a through hole defined in the annular end wall such that the plunger is at least partially surrounded by the hood wall; attaching the closure to the container body; and retaining a nutritive substance with at least one releasable seal between the closure and an inner chamber of the container body.

In another embodiment of the method, inserting the plunger in the through hole further includes placing the plunger in a sealing relationship with the annular end wall.

In one embodiment, the method includes forming a powder chamber in the closure, the powder chamber defined by the annular end wall, a powder chamber wall, the releasable seal, and the plunger.

In yet another embodiment, the method comprises the step of forming an insert containing the nutritive substance between two releasable seals.

Still another embodiment includes placing the insert having an insert ring along its circumference on a rim of the container body; and securing the closure to the container body, thereby forming a seal between the closure and the container body with the insert ring.

Another embodiment includes removably adhering a protective cover to the outside of the closure, thereby covering the plunger.

### BRIEF DESCRIPTION OF THE DRAWINGS

A full and enabling disclosure, including the best mode thereof directed to one of ordinary skill in the art, is set forth in the specification, which refers to the appended figures, in which:

FIG. 1 is a perspective view of a container in accordance with one embodiment of the present disclosure;

FIG. 2 is a partial perspective view of the container top illustrated in FIG. 1;

FIG. 3 is a side cross-sectional view of the container illustrated in FIG. 1;

FIG. 4 is a partial side cross-sectional exploded view of the container top illustrated in FIG. 1;

FIG. 5 is a side cross-sectional view of the container illustrated in FIG. 1 with the plunger in the actuated position;

FIG. 6 is a side cross-sectional view of a container in accordance with one embodiment of the present disclosure;

FIG. 7 is a partial side cross-sectional exploded view of the container top illustrated in FIG. 6;

FIG. 8 is a side cross-sectional view of the container illustrated in FIG. 6 with the plunger in the actuated position;

FIG. 9 is a perspective view of a container in accordance with one embodiment of the present disclosure;

FIG. 10 is a top view of the disk used in the container illustrated in FIG. 9;

FIG. 11 is an exploded perspective view of the container illustrated in FIG. 9.

Repeat use of reference characters in the present specification and drawings is intended to represent same or analogous features or elements of the disclosure.

### DETAILED DESCRIPTION

Reference now will be made in detail to the embodiments of the present disclosure, one or more examples of which are set forth herein below. Each example is provided by way of explanation of the nutritional composition of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

The technical problem to be solved by the present disclosure is to provide novel closures that are useful in delivering a nutritive substance to the contents of a container prior to consumption of the contents. Thus, in an embodiment, the present disclosure is directed to a container having a nutritive substance disposed inside the container closure. Before consumption of the contents of the container, the laminate seal may be peeled or altered such that the nutritive substance is released into the contents of the container. In other embodiments, the nutritive substance may be present on an insert in the interior of the container closure such that it does not contact the contents of the container until the container is altered by the consumer just before consumption.

“Nutritional composition” means a substance or formulation that satisfies at least a portion of a subject's nutrient requirements.

“Infant” means a subject ranging in age from birth to not more than about one year and includes infants from 0 to about 12 months corrected age. The term infant includes low birth weight infants, very low birth weight infants, and preterm infants. The phrase “corrected age” means an infant's chronological age minus the amount of time that the infant was born premature. Therefore, the corrected age is the age of the infant if it had been carried to full term.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

“Child” means a subject ranging in age from about 12 months to about 13 years. In some embodiments, a child is a subject between the ages of one and twelve years old. In other embodiments, the terms “children” or “child” refer to subjects that are two, three, four, five or six years old. In other embodiments, the terms “children” or “child” refer to any range of ages between about 12 months and about 13 years.

“Children's nutritional product” refers to a composition that satisfies at least a portion of the nutrient requirements of a child. A growing-up milk is an example of a children's nutritional product.

The term “growing-up milk” refers to a broad category of nutritional compositions intended to be used as a part of a diverse diet in order to support the normal growth and development of a child between the ages of about 1 and about 6 years of age.

“Nutritionally complete” means a composition that may be used as the sole source of nutrition, which would supply essentially all of the required daily amounts of vitamins, minerals, and/or trace elements in combination with proteins, carbohydrates, and lipids. Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant. A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant. A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

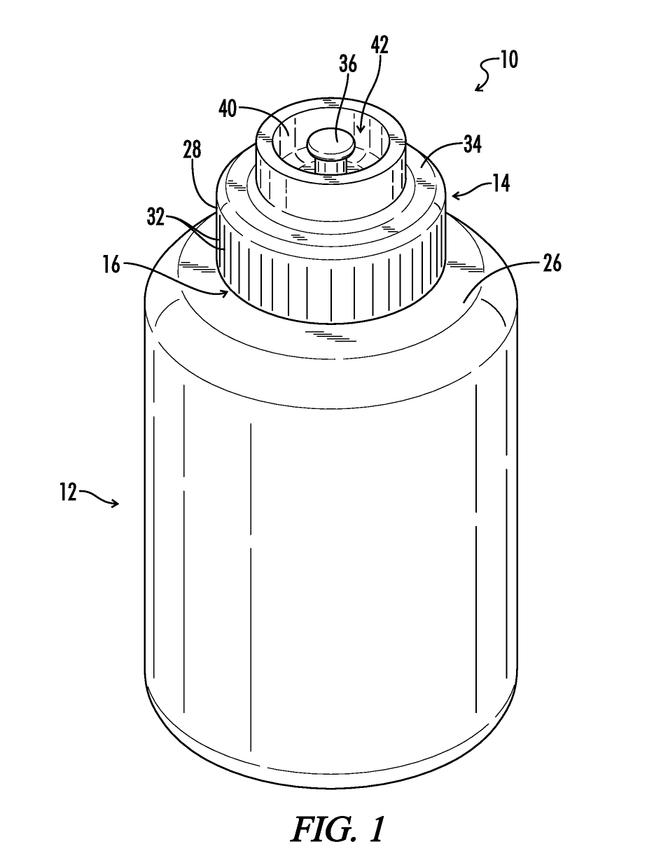

With reference now to the drawings, and in particular to FIGS. 1-5, an embodiment of a container 10 having a body portion 12, and a closure 14 is shown. The body portion 12 may include a cylindrical top portion 16. Cylindrical top portion 16 and body portion 12 may be integrally molded of a suitable polymer material, which may be blow molded, by extrusion, or injection, so that it is a unitary member of uniform wall thickness. Suitable polymers for forming the container 10 include, but are not limited to, polystyrene, polystyrene-acrylonitile, acrylonitile-butadiene-styrene, styrene-maleicanhydride, polycarbonate, polyethylene terephthalate, polyvinylcyclohexane, and blends thereof.

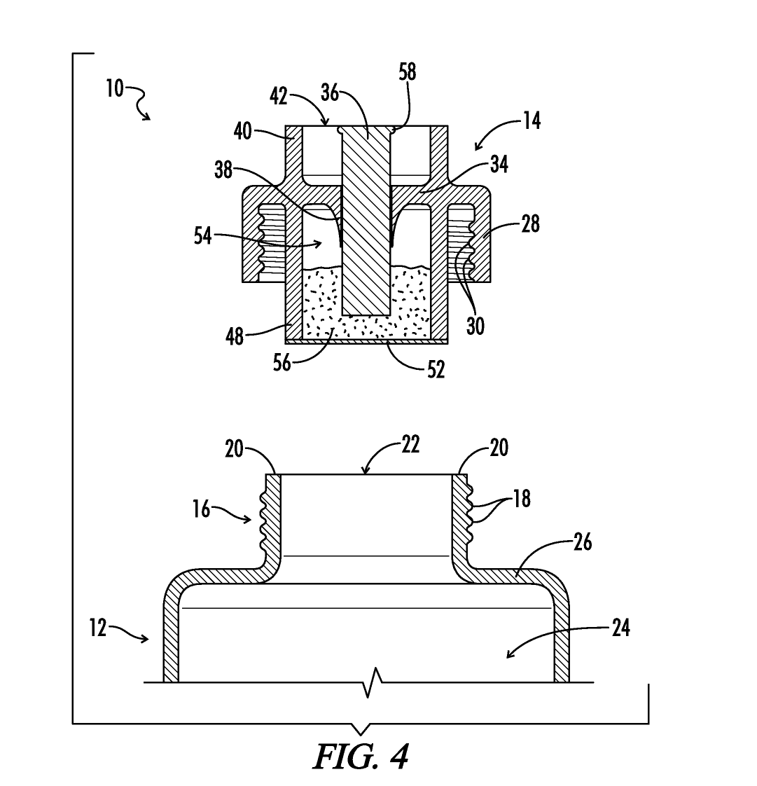

Referring particularly to FIG. 4, in some embodiments, cylindrical top portion 16 includes a helical thread 18. The helical thread 18 may be integrally formed on an outer surface of the cylindrical top portion 16 for threadedly receiving the closure 14. Cylindrical top portion 16 may have a rim 20 formed at one end thereof that defines an aperture 22 that is in fluid communication with an inner chamber 24 of the body portion 12. The helical thread 18 may begin proximate to the rim 20 and may terminate proximate a top wall 26 of the body portion 12.

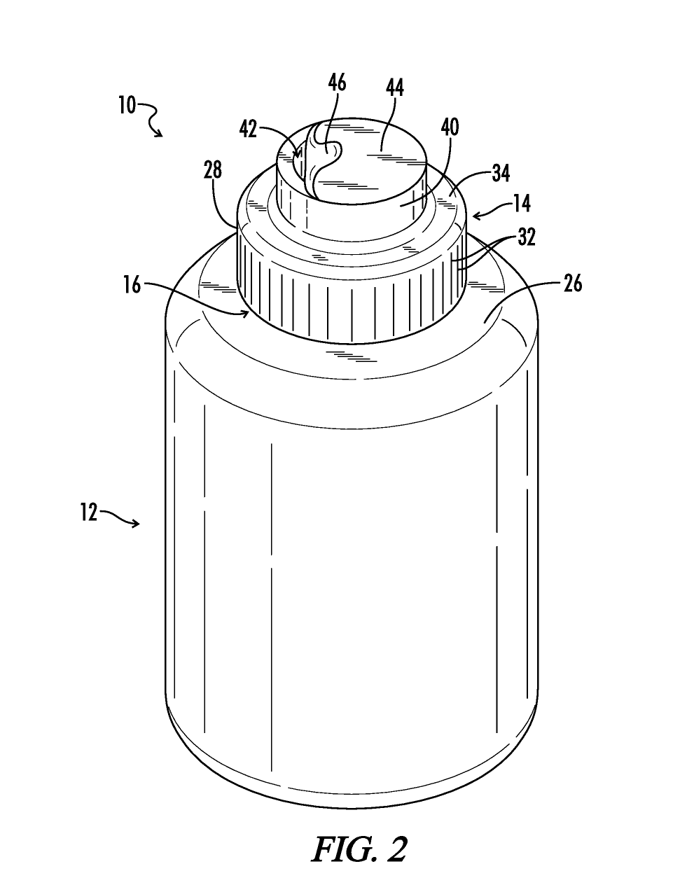

In an embodiment, the closure 14 includes an engagement wall 28 having a helical thread 30 (FIG. 4) on its inner circumference for operatively engaging the helical thread 18 of the cylindrical top portion 16. As shown in FIG. 1 and FIG. 2, the outer circumference of the engagement wall 28 may contain ribs or knurling 32 to allow the user to more easily grip the closure 14 to remove it from, or fit it on, cylindrical top portion 16.

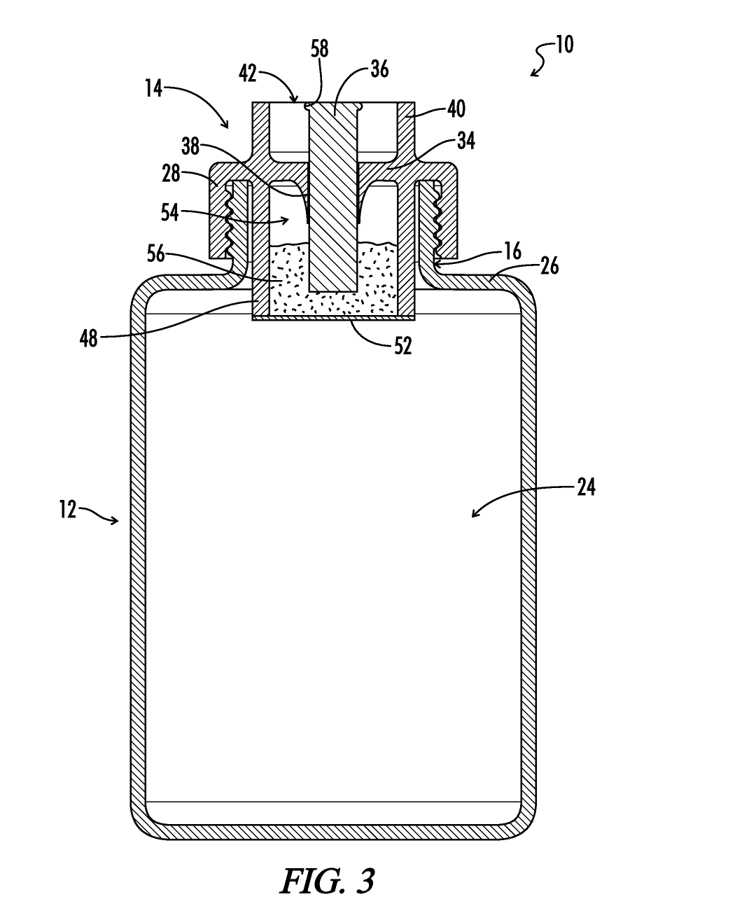

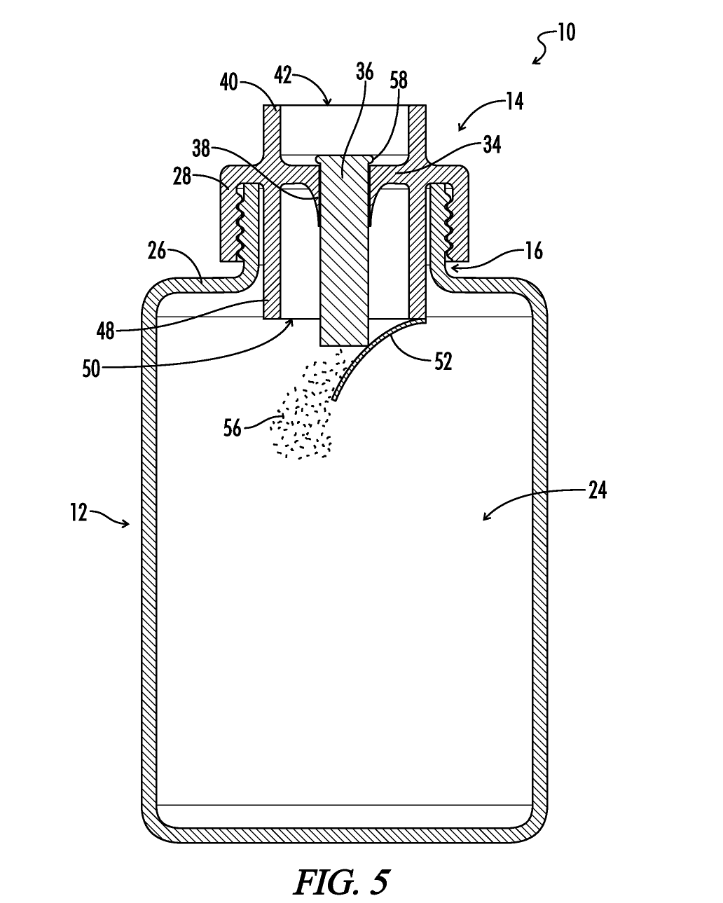

Closure 14 may also include an annular end wall 34 connected to the engagement wall 28 and defining a through hole (not shown) to receive a plunger 36. As shown in FIGS. 3-5, the annular end wall 34 may include a partial inner wall 38. The partial inner wall 38 may be comprised of resin and may envelop a length of the plunger 36 such that no portion of the plunger surface that was exposed to the outside environment in an unactuated position (FIG. 3) could be exposed to or otherwise contaminate the contents of the container 10 when the plunger is in the actuated position (FIG. 5).

The closure 14 may further include a hood wall 40 forming an opening 42 surrounding the plunger 36 and operatively secured to the annular end wall 34. Turning now to FIG. 2, with regard to the embodiments of FIGS. 1-8, a protective cover 44 may be removably adhered to an outside surface of the closure 14 (or the closure 114) so as to cover the plunger 36 (or the plunger 136). One non-limiting embodiment includes the protective cover 44 removably adhered to the hood wall 40. The protective cover 44 may include a gripping tab 46 to allow for easy removal of the protective cover. The gripping tab 46 may be formed from the same material as the protective cover 44 or may be formed of, or coated with, a different material to increase a user's ability to grip the gripping tab. The gripping tab 46 may be bonded to or integrally formed with the protective cover 44. The protective cover 44 and gripping tab 46 may be made of any appropriate material. The material may be flexible or non-flexible and may form a flat surface spanning the opening 42 or may form some other shape.

The closure 14 may also include a powder chamber wall 48 extending from the annular end wall 34 and defining an opening 50 (FIG. 5) opposite the annular end wall. The opening 50 may be sealed by a releasable seal 52 (FIG. 3 and FIG. 4), thereby forming a powder chamber 54 to contain a nutritive substance 56.

The plunger 36 may be moveable between an unactuated position (FIG. 3) where the nutritive substance 56 is prevented from flowing into the inner chamber 24 and an actuated position (FIG. 5) where the nutritive substance is able to flow into the inner chamber. The plunger 36 may have a radial protrusion 58 that extends beyond the plunger profile and thus could act as a stop upon full depression of the plunger into the actuated position. A consumer may depress the plunger 36 to actuate a downward motion and thereby peel away the releasable seal 52. In this arrangement, the nutritive substance 56 may be protected from exposure to the atmosphere and from the contents of the body portion 12. When the consumer is ready to consume the contents of the container 10, actuating the plunger 36 may cause the bond to fail between the releasable seal 52 and the powder chamber wall 48. The nutritive substance 56 may then fall into the inner chamber 24 of the body portion 12 to be mixed with its contents. Once the user has depressed the plunger 36 into the actuated position and released the nutritive substance 56, the user may shake the container 10 to mix the contents of the container with the nutritive substance prior to consumption.

When unfilled during manufacture and/or assembly, the powder chamber 54 may be spray-coated to impart better oxygen barrier properties if needed.

The releasable seal 52 covers the opening 50 of the powder chamber 54 to hold in the nutritive substance 56 until use. The releasable seal 52 would be applied after filling while the closure 14 is in an inverted orientation. The releasable seal 52 would be peelable so that it would release when depressed by the plunger 36. Alternately, the releasable seal 52 could be ruptured. The releasable seal 52 may be configured to remain at least partially attached to the powder chamber wall 48 so as to not be released into the inner chamber 24 with the added nutritive substance 56.

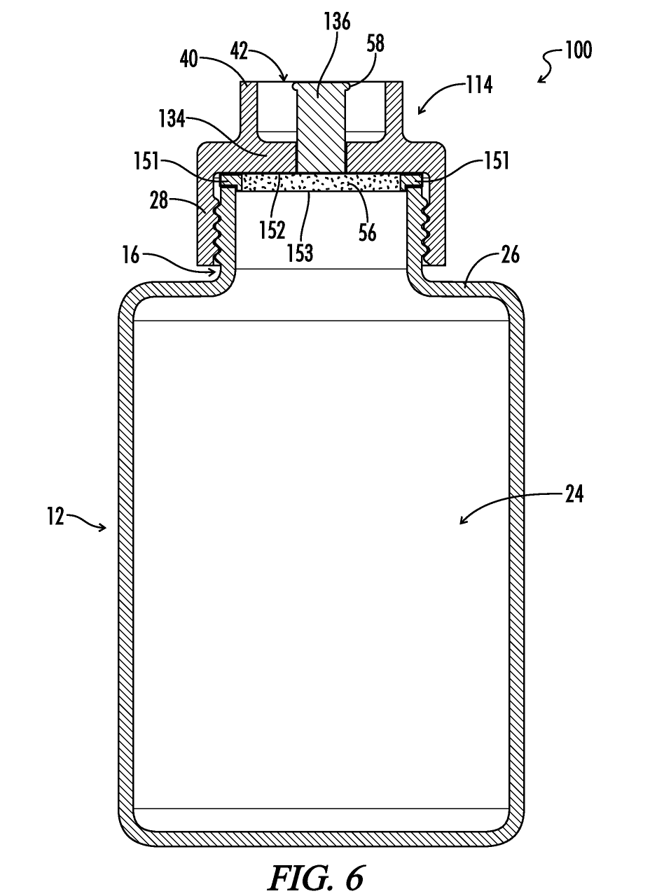

Referring to FIGS. 6-8, in another embodiment, container 100 includes a body portion 12 and a closure 114. The body portion 12 may be the same body portion as shown in FIGS. 1-5. Alternatively, the body portion of FIGS. 6-8 may be a different body portion.

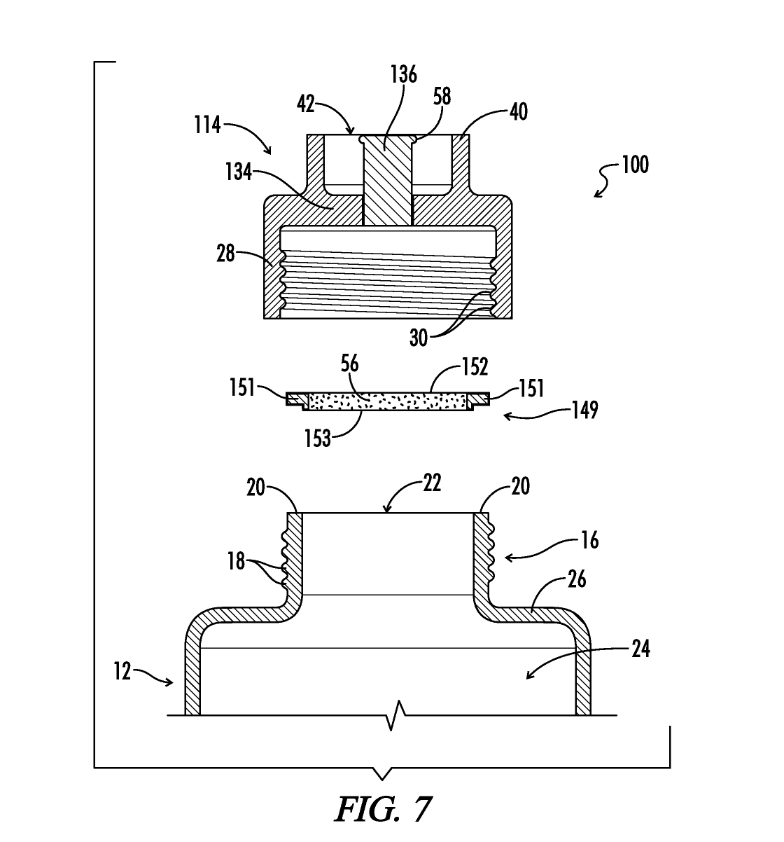

In some embodiments, closure 114 includes an engagement wall 28 having a helical thread 30 on its inner circumference (FIG. 7) for operatively engaging the helical thread 18 of the cylindrical top portion 16. Similar to the embodiment shown in FIG. 1 and FIG. 2, the outer circumference of the engagement wall 28 may contain ribs or knurling 32 to allow the user to more easily grip the closure 114 to remove it from, or fit it on, the cylindrical top portion 16.

The closure 114 may also include an annular end wall 134 connected to the engagement wall 28 and defining a through hole (not shown) to receive a plunger 136.

The closure 114 may further include a hood wall 40 forming an opening 42 surrounding the plunger 136 and operatively secured to the annular end wall 134.

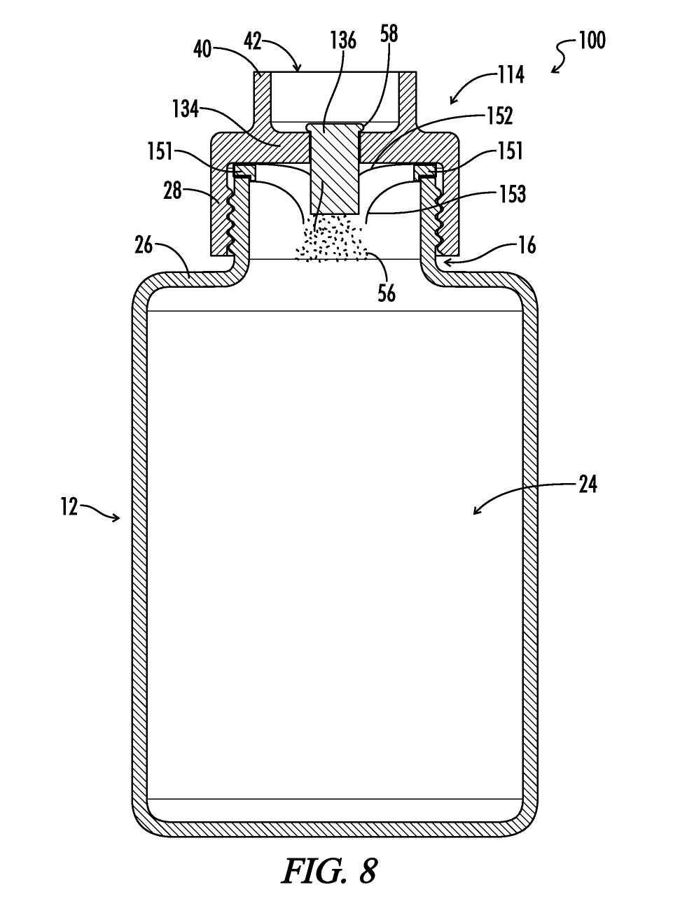

The plunger 136 may be moveable between an unactuated position (FIG. 6) where the nutritive substance 56 is prevented from flowing into the inner chamber 24 and an actuated position (FIG. 8) where the nutritive substance is able to flow into the inner chamber. The plunger 136 may include a radial protrusion 58 that extends beyond the plunger profile and thus could act as a stop upon full depression of the plunger into the actuated position.

An insert 149 may be attached to the rim 20 to cover the aperture 22. The insert 149 may include an insert ring 151 that may be attached to the rim 20 in a permanent or in a removable fashion or simply placed on top of the rim 20. The insert ring 151 may be of a material and sized to form a flat and conformable gasket that can seal between the body portion 12 and the closure 114. The insert 149 may include the nutritive substance 56 contained between two releasable seals 152, 153 adhered to the insert ring 151. The releasable seals 152, 153 may protect the nutritive substance 56 from the atmosphere until the insert 149 is used in the container 100. The releasable seals 152, 153 may also prevent the nutritive substance 56 from entering the inner chamber until the plunger 136 is moved to the actuated position.

A consumer may depress the plunger 136 to actuate a downward motion and thereby peel away the releasable seals 152, 153. Alternatively, the releasable seals 152, 153 may be ruptured. When the plunger 136 is moved to the actuated position (FIG. 8), the plunger may cause the bond to fail between the releasable seals 152, 153 and the insert ring 151. The nutritive substance 56 may then fall into the inner chamber 24 of the body portion 12 to be mixed with its contents. The releasable seals 152, 153 may be configured to remain at least partially attached to the insert ring 151 so as to not be released into the inner chamber 24. Once the user has depressed the plunger 136 into the actuated position and released the nutritive substance 56, the user may shake the container 100 to mix the contents of the container with the nutritive substance prior to consumption.

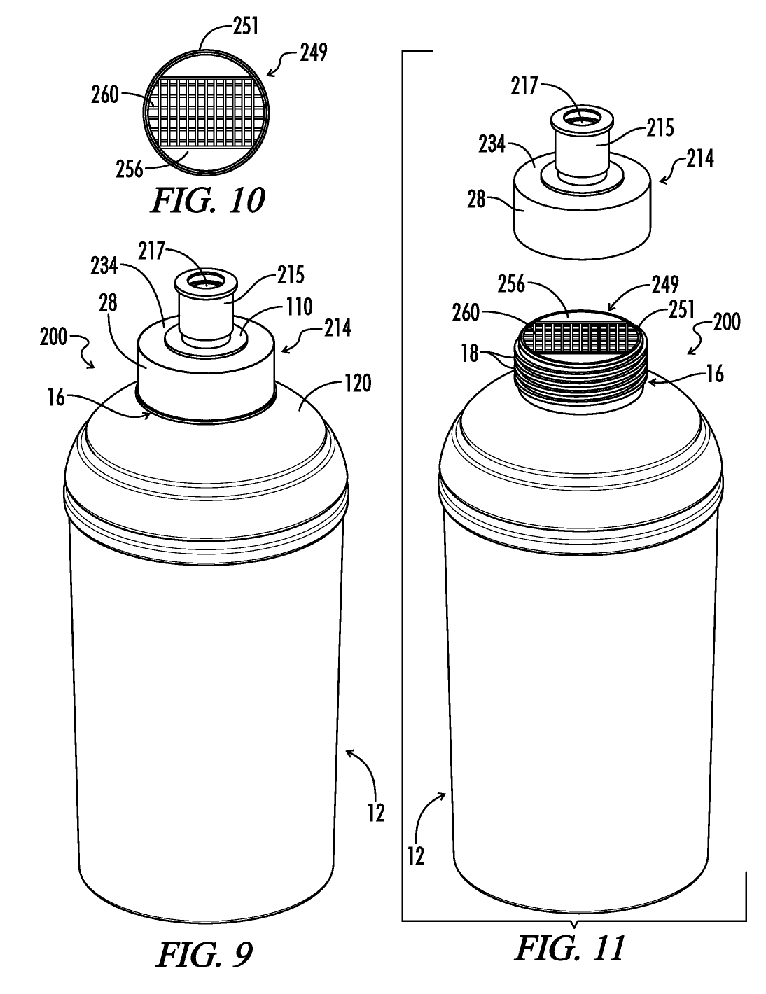

In another embodiment (FIGS. 9-11), a container 200 is provided with a body portion 12, a closure 214, and a disk 249. The body portion 12 may be similar to the body portion of the other embodiments, or it may differ from the other embodiments.

The closure 214 may be any typical closure that may be removably attached to the cylindrical top portion 16 of the body portion 12. The closure 214 may include an engagement wall 28 including a helical thread (not shown) on its inner surface for operatively engaging the helical thread 18 on the cylindrical top portion 16. An annular end wall 234 may be connected to the engagement wall 28 and defining a through hole (not shown). The closure 214 may further include a nipple 215 that may be movable between an open position and a closed position. The nipple 215 may cover the through hole by any means contemplated in the art including, but not limited to, making contact with a central finger 217 of the closure 214 to obstruct the through hole when the nipple is in the closed position.

Similar to the insert 149 of FIGS. 6-8, the disk 249 (FIG. 10 and FIG. 11) may be attached to the rim 20 over the aperture 22, or it may be attached to the inside of the closure 214. The disk 249 may be attached in any manner including, but not limited to, snap-fitting, press-fitting, with the use of adhesives, and the like. The disk 249 may also simply be placed on the rim 20 or in the closure 214. The disk 249 may be placed within the closure 214 or on the rim 20 prior to placing the closure on the body portion 12 of the container 200.

A covering (not shown) may surround the disk 249 prior to placement on the rim 20 or in the closure 214. The covering may be formed of any suitable material to ensure the nutritive substance layer 256 is protected from the atmosphere and other contaminants prior to use.

The disk 249 may be formed from a laminate having a lattice 260 formed in its center with a disk ring 251 formed on the periphery of the disk. The disk ring 251 may be a rigid, non-porous material and may be sized to lay flat on the rim 20. The disk ring 251 may form a flat and conformable gasket that can seal between the body portion 12 and the closure 214. The open, porous, or mesh-like lattice 260 may be fabric, molded woven or non-woven fabric, molded polymer, or any other material that is or can be rendered porous.

In some embodiments, a nutritive substance layer 256 is formed on the underside of the disk 249. The nutritive substance layer 256 may be deposited on the lattice 260 in such a way that it adheres, dries, or otherwise cures and remains adhered to the lattice. The resultant dried or cured nutritive substance layer 256 may be readily soluble in a liquid formula. Alternatively, a soluble carrier material may be deposited on the lattice 260 and used to adhere a powdered nutritive substance layer 256. A nutritive substance may deposited in a lined, dotted, or other pattern known or to become known in the art so that the lattice 260 may not be fully occluded by the nutritive substance layer 256.

When the disk 249 is placed in the container 200 and the container is inverted, the contents of the container may flow from the container through the lattice 260, contacting the nutritive substance layer 256 and providing a gradual release of the nutritive substance prior to or during consumption. Alternatively, the container 200 may be shaken to release the nutritive substance. One of skill in the art should understand that the structure of this disk 249 may be used with any number of different containers having varying shapes, sizes, and closures. The disks 249 may be packaged individually for single use in a small multi-pack that could match the quantity of bottles in one unit of sale. Packaging may be configured to ensure needed shelf-life of the nutritive substance layer 256. The packaging may also be configured to facilitate easy opening and hygienic handling.

In any embodiment of the current disclosure, the container may be in a parallelepipedic configuration, a gable-top configuration, or any other container shape known in the art or yet to be developed. The container may be, in a non-limiting example, square, rectangular, or round. Additionally, the closure in the embodiments may be of a variety of shapes that function to attach to the container body portion. In some embodiments, the closure may be over-molded with a skin surface that imparts barrier properties to protect ingredients and contents of the bottle to which it is sealed.

The container of any of the embodiments disclosed herein may be used to pour the contents out for use in a recipe or into another container for mixing with other ingredients or components. The container may also be used to pour out the contents into another container for consumption. In some embodiments, a consumer may drink directly from the container by placing the opening of the container to his or her mouth and inverting the container.

In each of the above described embodiments, the nutritive substance may be any known in the art. For example, the nutritive substance may be a macronutrient, a micronutrient, a bioactive agent, a long-chain polyunsaturated fatty acid, a probiotic, a prebiotic, a vitamin, a mineral, or combinations thereof. The nutritive substance may be a substance that is sensitive to heat, light, oxygen, moisture, or any component that is contained within the container body. In an embodiment, the nutritive substance is maintained as sterile until the user desires to mix the nutritive substance and the product within the container.

In a particular embodiment, the nutritive substance is a probiotic. The probiotic may be any probiotic known in the art. In particular embodiments, the probiotic is impregnated into a gum substrate. The gum substrate may, in some embodiments, comprise plant starches, instant hydratable starches, pregelatinized starches, instantized cold soluble starches, disintegratable starches, immobilized food-grade resins, or low-melting fats impregnated with disintegrating starches. In a particular embodiment, the gum substrate may comprise a low-melting fat impregnated with a disintegrating starch, which on contact with water can swell and release the probiotic. In another embodiment, the gum substrate may comprise an immobilized food-grade resin, which can be used to adsorb the probiotic. Upon contact with water, the immobilized food grade resin readily dislodges the probiotic. In particular embodiments, hydrophilic substances, such as emulsifiers, can be included in the gum substrate to assist in the release of the probiotic upon contact of the probiotic with the product.

In another embodiment, the probiotic may be applied as a powder that is suspended in an oil- or wax-based suspension. Any oil or wax known in the art may be utilized in this embodiment, provided it does not adversely affect the properties of the container or the contents of the container.

In at least one embodiment, the probiotic may be Lactobacillus rhamnosus GG. In another embodiment, the probiotic may be Bifidobacterium BB-12. In a particular embodiment, the probiotic may be a combination of Lactobacillus rhamnosus GG and Bifidobacterium BB-12. In some embodiments, the level of probiotic present is within the range of about 1×10⁵ colony forming units (cfu) per gram formula to about 1×10¹⁰ cfu per gram formula. In other embodiments, the level of probiotic present is within the range of about 1×10⁶ colony forming units (cfu) per gram formula to about 1×10⁹ cfu per gram formula. In some embodiments, the level of probiotic present is within the range of about 1×10⁶ colony forming units (cfu) per gram formula to about 1×10⁸ cfu per gram formula.

Because many probiotics are sensitive to heat and may be damaged or killed if subjected to the heat treatment that is necessary for many food and drink products, the present disclosure provides the compartmentalized storage of a probiotic. In the present disclosure, the product contained within the container may undergo heat treatment or sterilization during the packaging process. After the product has been packaged into a container and sterilized, a seal containing a probiotic layer may be affixed to the container. Alternatively, the probiotic may be contained on an insert as described herein or may be coated within the upper portion of the container or the container closure. The package may then be prepared for shipment or display. In these configurations, the probiotic is not subjected to damaging heat treatment during packaging and is kept separate from the product itself until consumption, at which time the two can be intermixed.

Thus, in some embodiments, the disclosure comprises a method for making a delivery apparatus comprising a) providing a container as described herein; b) filling the container with a product; c) sterilizing the product-filled container; d) sealing the container with a laminate seal as described herein; and e) placing a closure on the container.

The product contained within the container may be any product known in the art. In some embodiments, the product is in a form selected from a liquid, ready-to-use product, liquid concentrate, fluid, powder, suspension, emulsion, or combination thereof. In some embodiments, the product contained within the container is a food or drink product. In a particular embodiment, the product contained within the container is a nutritional supplement for children or adults.

While the container itself may be constructed from a polymer such as polystyrene, polystyrene-acrylonitile, acrylonitile-butadiene-styrene, styrene-maleicanhydride, polycarbonate, polyethylene terephthalate, polyvinylcyclohexane, and blends thereof, the container may also be constructed from paper, cardboard, or another fibrous material, optionally coated with a plastic material or foil laminate. Similarly, the container could be constructed from a flexible film, thereby providing a flexible pouch.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the versions contained therein.

What we claim is:

1. An apparatus for powder dosing a nutritional composition comprising:
a. a container body including:
i. an upper portion adapted for removable receipt of a closure, the upper portion defining an opening therein, and
ii. a cavity defined by the container body, the cavity being in fluid communication with the upper portion opening; and
b. the closure removably coupled to the upper portion, the closure including:
i. an annular end wall,
ii. a plunger member molded in the annular end wall,
iii. a powder chamber formed inside of the closure and loaded with a nutritive substance, and
iv. a laminate seal, the laminate seal being bonded across the powder chamber and adapted to peel when the plunger is depressed.

2. The apparatus of claim 1, wherein the seal prevents contact between the nutritive substance and contents of the container body until the seal is peeled.

3. The apparatus of claim 1, wherein the plunger comprises a first resin.

4. The apparatus of claim 3, wherein the annular end wall comprises a second resin.

5. The apparatus of claim 1, wherein the powder chamber is spray-coated.

6. The apparatus of claim 1, wherein the nutritive substance comprises a probiotic.

7. The container of claim 1, wherein a protective cover is removably adhered to an outer surface of the closure and covers the plunger.

8. The container of claim 7, wherein the protective cover comprises a gripping tab to allow easy removal of the protective cover.

9. An apparatus for powder dosing a nutritional composition comprising:
a. a container body including:
i. an upper portion adapted for removable receipt of a closure, the upper portion defining an opening therein, and
ii. a cavity defined by the container body, the cavity being in fluid communication with the upper portion opening, and
b. the closure removably coupled to the upper portion, the closure including:
i. a disk formed with an open lattice center and disposed between the container body and the closure, and
ii. a heat-sensitive ingredient deposited on the underside of the disk.

10. The apparatus of claim 9, wherein the disk includes a disk ring along a circumference of the disk, the disk ring sealingly positioned between the closure and the upper portion when the closure is coupled to the upper portion.

11. The apparatus of claim 10, wherein the closure is formed with a nipple.

12. The apparatus of claim 10, wherein the disk is permeable.

13. The apparatus of claim 9, wherein the apparatus is inverted to expose the heat-sensitive ingredient to contents of the container body.

14. The apparatus of claim 9, wherein the heat-sensitive ingredient comprises a probiotic.

15. A method of manufacturing an apparatus for powder dosing a nutritional composition, the method comprising:
a. providing a container body;
b. providing a closure including an annular end wall and a hood wall;
c. inserting a plunger in a through hole defined in the annular end wall such that the plunger is at least partially surrounded by the hood wall;
d. attaching the closure to the container body; and
e. retaining a nutritive substance with at least one releasable seal between the closure and an inner chamber of the container body.

16. The method of claim 15, wherein step (c) further includes placing the plunger in a sealing relationship with the annular end wall.

17. The method of claim 15, further comprising the step of forming a powder chamber in the closure, the powder chamber defined by the annular end wall, a powder chamber wall, the releasable seal, and the plunger.

18. The method of claim 15, further comprising the step of forming an insert containing the nutritive substance between two releasable seals.

19. The method of claim 18, wherein step (e) further comprises:
placing the insert having an insert ring along its circumference on a rim of the container body; and
securing the closure to the container body, thereby forming a seal between the closure and the container body with the insert ring.

20. The method of claim 15, further comprising the step of removably adhering a protective cover to the outside of the closure, thereby covering the plunger.
